(19) United States
(12) Patent Application Publication
(10) Pub. No.: US 2008/0081091 A1
(43) Pub. Date: Apr. 3, 2008

(54) Nutritional bar composition and nutritional system

(75) Inventor: Ronald Reda, Chicago, IL (US)

Correspondence Address: SEYFARTH SHAW LLP, 131 S. DEARBORN ST., SUITE 2400, CHICAGO, IL, 60603-5803, US

(73) Assignee: Nextbody LLC

(21) Appl. No.: 11/904,216

(22) Filed: Sep. 26, 2007

Related U.S. Application Data
(60) Provisional application No. 60/848,085, filed on Sep. 29, 2006.

(51) Int. Cl. A23L 1/30

(52) U.S. Cl. 426/87; 426/394; 426/648

(57) ABSTRACT

A food delivery system packaged individually yet together in a perforated sequentially numbered system to be consumed in a pre-determined time frame spreading out ones caloric intake over a period of time throughout the day. The food delivery system has individual compartments connected via a perforated tear away forming one long strip of individual packets. The food delivery system has a pre-determined amount of food, calories, carbs, protein, fat, vitamins and minerals in the individual packets consumed at certain intervals throughout the day culminating to ones total caloric intake at the end of the day. The food delivery system combines pre-determined daily caloric intake with a pre-determined time frame for consumption.

This application claims the priority filing date of copending application Ser. No. 60/848,085 filed Sep. 29, 2006.

### BACKGROUND OF THE INVENTION

The present invention pertains to a nutritional bar composition packaged as a strip of nutritional bars and a nutritional system for delivering pre-determined levels of dietary components.

Whereas, there are prior diets and foods concerning weight loss and nutritional supplements, none of the prior art addresses the new and patentable unique features of the present invention.

Known weight loss diets and nutritional bars in particular are singularly based bars with no thought as to the total caloric intake for the day. They are meant as a supplement or in some cases meal replacement. These bars do not consider one's total caloric intake for the day and therefore do not constitute a system for weight loss. Before the advent of the current invention other systems that provide food require much work on the part of the participant to refrigerate, store, transport and cook via microwave or stove top. These systems are cumbersome and create stress for the participant to plan well ahead of time where and how they will prepare their meals, in many cases the means to do this throughout the day is not even possible. Still other weight loss diets are books providing recipes for the participants to thoroughly read, make a shopping list, buy all the food, a scale to weigh the food, special seasoning and then spend countless hours preparing the food for the week ahead. Then there is the task again of transportation, refrigeration and cooking. As one can obviously see these diets fail because they are too much work and time consuming. 95% of people that lose weight gain all of it back with the first year. This new/unique diet aims to solve this.

Most diets fail because long term they become too stressful and too much trouble for the participants. Of the top selling diets Jenny Craig, Weight Watchers, Nutrisystems, Slim Fast and Seattle Suttons all sell you food that needs to be refrigerated and then transported in a cooler and then heated up for consumption. Of the other top diets on the market South Beach, Atkins and the Zone all are books that present lots of nutritional information and then give you a lot of meals to go out and prepare. Preparing these meals takes a tremendous effort and requires lots of time from reading them, making a grocery list, going to the store and then preparing them. All these diets prescribe eating 3 meals a day. This is old school thinking, through enormous amounts of studies and research it is a scientific fact that the more often you eat (the right foods) the better your body works to release the fat and become a fat burning furnace.

The current diets on the market require a lot of time and energy on the part of the participant trying to lose weight. You may need to count calories, count points, count fat, count carbohydrates, cook special food day in and day out, plan mealtimes far in advance, call a service for your food, consider your work conditions or environment for cooking or processing the food and transporting the food for your daily consumption. These conditions are very time consuming and causes great stress on the participants of these diets. All weight loss in the human body is the result of one thing only and there are various paths to get there. One must burn more calories then he/she take in on a daily basis to have measurable weight loss. All diets are based on this caloric restriction in some way. Most diets fail to control daily intake that is why there is a 95% failure rate within the first year.

Other than diets weight loss diets, there are other known nutritional systems that are used to maintain weight and for other health purposes. However, no such systems can provide the overall benefits of the nutritional strip of the present invention that is useful for many applications such as the nutritional strip of the present invention for weight maintenance, children health, athletes diet, drug delivery and health disorders such as diabetes.

### SUMMARY

The present invention provides for a series of nutrition bars having a composition comprising a first nutrition bar having a first amount of calories, carbohydrates, protein and fats, a second nutrition bar having a second amount of calories, carbohydrates, protein and fats, a third nutrition bar having a third amount of calories, carbohydrates, protein and fats and the first, second and third amounts of calories, carbohydrates, protein and fats providing a total daily intake of calories, carbohydrates, protein and fats that provide a predetermined daily dietary plan for an individual. In an embodiment the first, second and third nutrition bars provide a total of between about 900 to 2,900 calories daily, 60 to 223 grams of carbohydrates daily, 50 to 167 grams of protein daily and 0 to 75 grams of fat daily.

In further embodiment, the present invention provides for a system for controlling caloric intake comprising a series of at least three food bars packaged together in a strip, each food bar is separated from the next and may be removed from the strip without disrupting the adjacent food bar and each food bar is labeled in order to identify a sequence by which the food bars are to be consumed so that upon ingestion of each of the food bars a total daily caloric intake will be achieved and the total caloric intake consistent with a predetermined diet plan.

In an embodiment the specified diet plan is for weight reduction. In an embodiment the specified diet plan is for weight reduction for women. In an embodiment the specified diet plan is for women having a body weight of less than 175 pounds. In an embodiment the specified diet plan is for women having a body weight of more than 175 pounds. In an embodiment the specified diet plan is for men. In an embodiment the specified diet plan is for men having a body weight of less than 225 pounds. In an embodiment the specified diet plan is for men having a body weight of more than 225 pounds. In an embodiment the specified diet plan is for people weighing over 300 pounds (T-3). In an embodiment the specified diet plan is for weight maintenance. In an embodiment the specified diet plan is for sports training. In an embodiment the specified diet plan is for treatment of diabetes, high cholesterol, high blood pressure, high sodium. In an embodiment the specified diet plan is for optimal drug delivery. In an embodiment the specified diet plan is for a children's diet and silver diet for elderly, and weight gain strip.

In an embodiment at least one food bar is a snack bar and at least one food bar is a mealtime bar and each food bar labeled so that the snack bar is directed to be consumed about two hours after the mealtime bar in order to stimulate the user's metabolism. In an embodiment the strip contains six food bars and at least two of the food bars are designated as snack bars and at least two of the food bars are designated as mealtime bars and each food bar is labeled so that the snack bars are directed to be consumed about two hours after the mealtime bar in order to stimulate the user's metabolism.

In another embodiment the invention provides for a method of controlling caloric intake and stimulating a users metabolism over a daily duration comprising the steps of providing a series of at least three food bars packaged together in a strip, removing a first food bar labeled with the numeral “1” from the strip and consuming the food bar as first meal, removing a second food bar labeled with the numeral “2” from the strip and consuming the food bar as a second meal about two hours after the first meal, removing a third food bar labeled with the numeral “3” from the strip and consuming the food bar as a third meal about two hours after the second meal and consuming a total predetermined caloric intake in order to provide prescribed diet plan.

In an embodiment the steps include removing a fourth food bar labeled with the numeral “4” from the strip and consuming the food bar as a fourth meal about two hours after the third meal. In an embodiment the steps include removing a fifth food bar labeled with the numeral “5” from the strip and consuming the food bar as a fifth meal about two hours after the fourth meal. In an embodiment the steps include removing a sixth food bar labeled with the numeral “6” from the strip and consuming the food bar as a sixth meal about two hours after the fifth meal.

In an embodiment the first bar contains between about 213 to 464 calories, the second bar contains between about 100 to 300 calories, the third bar contains between about 213 to 464 calories, the fourth bar contains between about 100 to 300 calories, the fifth bar contains between about 100 to 300 calories and the sixth bar contains between about 175 to 398 calories. In an embodiment the first bar contains between about 9 to 42 grams of protein, the second bar contains between about 5 to 23 grams of protein, the third bar contains between about 9 to 42 grams of protein, the fourth bar contains between about 5 to 23 grams of protein, the fifth bar contains between about 5 to 23 grams of protein and the sixth bar contains between about 7 to 37 grams of protein. In an embodiment, the first bar contains between about 1 to 20 grams of fats, the second bar contains between about 1 to 8 grams of fat, the third bar contains between about 1 to 20 grams of fat, the fourth bar contains between about 1 to 8 grams of fat, the fifth bar contains between about 1 to 8 grams of fat and the sixth bar contains between about 1 to 20 grams of fat. In an embodiment, the first bar contains between about 10 to 75 carbs, the second bar contains between about 7 to 33 carbs, the third bar contains between about 10 to 75 carbs, the fourth bar contains between about 7 to 33 carbs, the fifth bar contains between about 7 to 33 carbs and the sixth bar contains between about 10 to 75 carbs. In an embodiment the first, third and sixth food bars contain a higher amount of calories than the second, fourth and fifth food bars so that consumption of the series of second, fourth and fifth food bars causes the users metabolism to be stimulated. In an embodiment the first food bar contains a higher amount of calories than the second food bar and the third food bar contains a higher amount of calories than the second food bar so that consumption of the series of three food bars causes the users metabolism to be stimulated. In an embodiment, the sixth bar has less calories than the first and third bars but higher than the second, fourth and fifth bars. In an embodiment the packaging provides serrated portions provided between each food bar to separate each of the food bars from the next food bar on the strip so that a user may easily remove each food bar in sequence throughout each day for consuming each food bar according to the predetermined sequence.

The nutritional bars and combination strip of the present nutrition system is an improvement over all other diets and nutrition systems and has considered these conditions and has solved them in a very creative and healthy way. The nutritional strip has also considered the physical/mental aspect of dieting and how the body's metabolism and biorhythms work. The nutritional strip has eliminated the work and thinking of dieting on the part of the participant, there are no decisions to be made, no calories to count, no points to count, no cooking and no un-proven chemical laced pills to take when you are on the nutritional strip. The nutritional strip has pre-made all these decisions for you to get you to your ideal weight. The methodology behind the nutritional strip is based on how the body reacts to food and calories. In order for your body to optimize its weight loss and fat burning your metabolism needs to be activated 6 times a day throughout a 24 hour period. The nutritional strip takes full advantage of this fact. nutritional strip is a food delivery system packaged individually yet together in a perforated sequentially numbered system to be consumed in a pre-determined time frame spreading out ones caloric intake over a period of time throughout the day. The nutritional strip system has individual compartments connected via a perforated tear away forming in theory one long strip of individual packets. These packets are numbered to determine the sequence in which the food packets are to be consumed. The strip has a pre-determined amount of food, calories, vitamins and minerals in the individual packets consumed at certain intervals throughout the day culminating to ones total caloric intake at the end of the day. The nutritional strip is the first and only diet on the market today that combines pre-determined caloric intake with a pre-determined time frame in a singular strip.

The nutritional strip incorporates a full day's supply of food and nutrients in a portable delivery system packaged individually yet maintained together in a perforated sequentially numbered system to be consumed more than 3 times per day in a pre-determined time frame spreading out one's caloric intake over a period of time throughout the day. The food delivery system has individual compartments connected via a perforated tear away forming one long strip of individual compartments. The food system is numbered to determine the sequence in which the food packets are to be consumed. The food delivery system has a pre-determined amount of food, calories, vitamins and minerals in the individual packets consumed at certain intervals throughout the day and cumulating one's total caloric intake at the end of the day. The food delivery system is the first and only diet on the market today that combines more than 3 food ingestions per day with a pre-determined caloric intake with a pre-determined time frame, thus maximizing one's own metabolism throughout the day to produce the metabolic result of burning more calories faster and losing weight.

The nutritional strip is a food delivery system that has individual compartments connected via a perforated tear away forming in theory one long strip of individual packets that are sequentially numbered to be consumed in a pre-determined time frame (for example every 2 hours) spreading out ones caloric intake over a period of time throughout the day. This strip has a pre-determined amount of food, calories, vitamins and minerals in the individual packets consumed at certain intervals throughout the day culminating to ones total caloric intake at the end of the day. The nutritional strip is the first and only diet on the market today that combines pre-determined caloric intake with a pre-determined time frame.

Most diets fail because long term they become too much trouble for the participants. The participants are required to keep track of something such as carbohydrates, calories, fat, points etc. Still others require the participants to attend costly monthly meetings and embarrassing weigh ins. This counting and meetings leads to discontent with the process and eventually they go off the diet and back to their overweight condition.

What if there was a diet that didn't require the participants to do anything! The nutritional strip diet solves these problems by pre-determining the daily caloric intake of the participant. There is nothing to count or keep track of, it is all pre-done for the participants in an easy to ingest food delivery system that travels and easily fits into the busiest of life styles without requiring the user to think carefully or count calories.

Problem: Most diets have you eating 3 times a day. Scientific research shows that eating 3 times a day is not the optimum way to lose weight. You need your metabolism to be active far more often than that. Most diets on the market today are still promoting the 3 square meals a day to lose weight. Research has now proven that the more often you eat the more often your metabolism kicks in and burns calories and thereby burns fat. Your metabolism becomes a “fat burning furnace” when you keep it active. Of course eating the wrong foods more often can be counter productive.

The nutritional strip capitalizes on this fact and optimizes the metabolism into high gear by having the participant taking in small amounts of food precisely spaced out over a 24 hour period. The nutritional strip combines pre-determined caloric intake with a pre-determined time frame with an easy to use distribution system that requires little effort on the part of the participant.

Problem: Most diets require some type of food preparation. Most diets on the market today require some sort of food preparation, they may tell you what to buy or sell you the food themselves but they still require some type of preparation, work and thought on the part of the participants.

The nutritional strip requires no food preparation; everything is pre-done pre-packaged for the participant. You simply take the nutritional strip with you in the morning and have your full day's supply of food with you with no preparation required.

Problem: Most diets are not very portable. Most diets require the participant to lug around lots of Tupperware with their daily food that they had to prepare. Some food may be required to stay cool or warm. Again this requires a lot of effort, thinking and work on the part of the participants leading to discouragement of the diet.

The nutritional strip solves this problem with its unique patented packaging system that is easy to carry and take with you anywhere.

Problem: Most diets fail because they require the participants to do all the work. The nutritional strip of the present invention succeeds because the system accomplishes the dietary goals without allowing any excuses for the participants. All that's left for the participant to do is open each bar from the strip, consume the bar and in the case of the weight loss strip, lose weight without overthinking, counting, nor food preparation.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its constructions and operation, and many of its advantages should be readily understood and appreciated.

FIG. 1 is a flow chart that describes an embodiment of the steps of practicing the system of the present invention.

FIG. 2 is a perspective view of a strip of nutrition bars of a second embodiment of the present invention.

FIG. 3 is a side view of a strip of nutrition bars of a third embodiment of the present invention.

FIG. 4 is a side view of a strip of nutrition bars of a fourth embodiment.

FIG. 5 is a side view of a strip of nutrition bars of a fifth embodiment.

FIG. 6 is a plan view of a strip of nutrition bars of a sixth embodiment.

FIG. 7 is a plan view of a strip of nutrition bars of a seventh embodiment.

FIG. 8 is a plan view of a strip of nutrition bars of an eighth embodiment.

FIG. 9 is a perspective view of a strip of nutrition bars of a ninth embodiment.

FIG. 10 is a side view of a strip of nutrition bars of a tenth embodiment.

FIG. 11 is a side view of a strip of nutrition bars of an eleventh embodiment.

FIG. 12 is a side view of a strip of nutrition bars of a twelfth embodiment.

### DETAILED DESCRIPTION

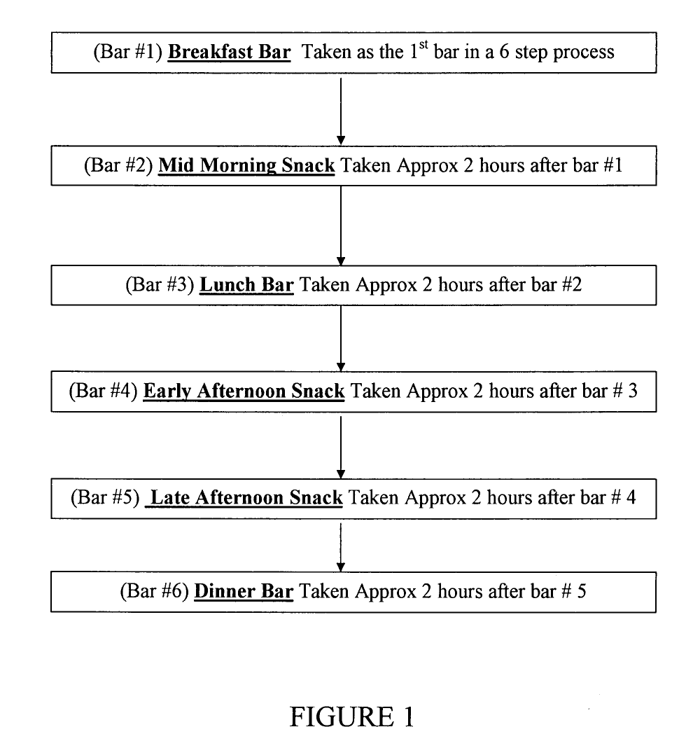

In an embodiment, the nutrition system provides nutrition bars attached together as a strip of bars and a method of controlling consumption of the bars to attain a daily intake of a predetermined amount of calories, nutrients, vitamins, protein, carbohydrates and fat. In some embodiments the nutrition strip may have only three nutrition bars and others may have as many as six bars. For example, an embodiment of the present invention is depicted in FIG. 1 where a first breakfast bar is removed from the strip and consumed. Two hours later a second mid-morning snack bar is removed from the strip and consumed. Two hours later a third lunch bar is removed and consumed. Two hours later a fourth snack bar is removed from the strip and consumed. Two hours later a fifth snack bar is separated from the sixth bar and consumed. The final remaining dinner bar is then consumed two hours after the fifth bar. By following such a system, as marked on each individually packaged bar, a person can control daily intake of his/her nutrition requirements in order to address specific health concerns as discussed below. Thus, by providing a strip of bars for mealtimes (e.g. breakfast, lunch and dinner) and for snacks (all mealtime bars and snack bars collectively referred to as meal bars or meals) a person may control his/her daily intake of calories, nutrients, carbohydrates, nutrients, vitamins, fats and protein with each strip.

Each bar of the present invention described below may contain a variety of and mixture of components and nutrients including vitamin A, B3, B5, B6, B12, C, D, E, thiamin, riboflavin, niacin, Folic Acid, biotin, pantothenic acid, calcium, iodine, magnesium, zinc, iron, selenium, copper, manganese, chromium, molybdenum, potassium, alpha lipoic acid, inositol, lycopene, lutein esters, citrus bioflavonoid dehydrate, Dried Kale, Alfalfa, mixed tocopherols, apple extract, asparagus, holy basil, blueberry, grape, oregano, prune, rosemary, broccoli, cranberry, watercress, parsley, pomegranate, flax seed, omega oils, sage, horseradish, nuts, strawberry, rice, oats, flour, yogurt, fudge, chocolate and other components.

Each type of nutritional strip includes a series of bars packaged in compartments separated by perforation for use of each bar during a single day's process of ingesting the bars according to the system of the present invention. Multiple embodiments of the present invention will be presently described including a Maintenance Strip, Diabetic Strip, Kids Strip, Athletic Strip, Drug Delivery Strip, Silver Strip for elderly people, Weight Gain Strip and a Weight Loss Strip. However, it is to be understood that the present invention may also pertain to other types of strips and nutrition systems. Each strip uses a series of nutrition bars of a predetermined composition packaged together in a strip of bars according a nutrition system to accomplish the dietary and health goals for each individual. Further, the benefits of each of these individual types of systems may be combined in different arrangements in a single nutrition strip.

### I. Maintenance Strip

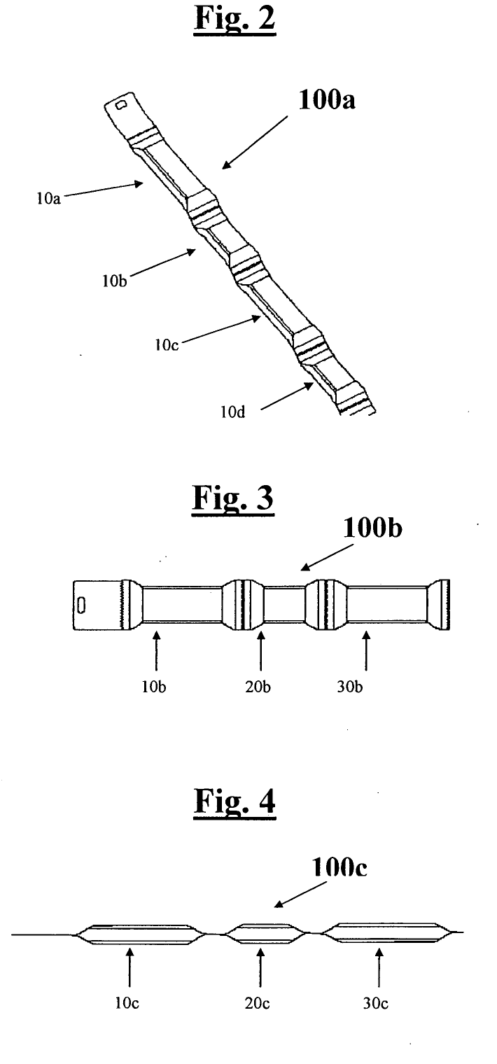

Maintaining weight loss is just as difficult or more difficult than losing weight. The maintenance strip 100a depicted in FIG. 2 offers a solution to this dilemma by providing and controlling 67% of one's daily caloric intake. The maintenance strip 100a achieves this by providing four food bars in a strip for controlling ⅔ of the caloric intake as depicted in FIG. 2. A mealtime is substituted in between consumption of the four bars. The participant decides which mealtime they will eat for the day. If breakfast is chosen then one would have their four bars 10a, 20a, 30a, 40a starting 2 hours after breakfast and continuing every 2 hours thereafter. If lunch were chosen one would have a first bar 10a at 4 hours before lunch and then a second bar 20a 2 hours before lunch. Then the person would have lunch. Following lunch 2 hours later and then 2 hours after that consume the fourth and final bar 40a. If dinner were chosen one would have 4 bars 10a, 20a, 30a, 40a prior to dinner spaced out every 2 hours prior to. The maintenance strip would also have all of the vitamins and minerals recommended. By providing the Maintenance strip 100a so that it has four bars to be eaten daily in addition to one meal, a persons metabolism can be trained to turn on at the beginning of the day and run for 10 to 12 hours until the last meal bar (or mealtime food) is consumed. Thus, during each 24 hour period a persons metabolism is burning calories during the 10 hour period that the meal bars and or mealtime food is being consumed. In this way a persons metabolism is trained and maintained in a way to burn maximum calories so that a user can maintain his/her desired weight. Such control of a persons metabolism is a feature of each of the types of strips described below. Below is a Table T-1 that depicts the calorie range for female (MSF) and male (MSM) in an embodiment of the maintenance strip 100a

TABLE T-1

| Maintenance | | |
|---|---|---|
| Strip | Low Calories | High Calories |
| MSF | 800 | 1,350 |
| MSM | 1,200 | 1,800 |

### II. Diabetic Strip

Diabetes among adults and children is at its highest level in history and rising at an alarming rate. The lack of time to properly eat and the duel working families has put less importance on eating and nutrition than on getting to work and school on time. Because of this change in social behavior there has been a steep rise in type 2 diabetes among adults and children. Once one is diabetic, their body changes drastically and they need to eat smaller amounts of food 5-6 times per day. Diabetics require snacks in-between their regular mealtimes to keep their glycemic levels up and regular.

The diabetic strip 100b is a 3 food bar strip as shown in FIG. 3 that is to be eaten in between mealtimes throughout the day. The first bar 10b is eaten in between breakfast and lunch, the 2^{nd} bar 20b is eaten 2 hours after lunch, the 3^{rd} bar 30b is eaten 2 hours after that and then non-bar dinner is eaten 2 hours after the last bar. These strips are especially helpful for kids with diabetes since the parents can't be with them all the time to make sure they are eating healthy snacks. Below is a table T-2 that depicts the calorie range for an embodiment of the diabetic strip for a child (DSC) and an adult (DSA).

TABLE T-2

| Diabetic Strip | Low Calories | High Calories |
|---|---|---|
| DSC | 200 | 400 |
| DSA | 250 | 600 |

### III. Kids Strip

The Kids Strip is targeted for the “on the go” family of today. Today with dual working parents and constant on the go from school to daycare to home, there is not time for cooking or preparing meals. Pre-packaged foods have become all the rage. Children are missing out on health foods and snack food in particular.

The Kids Strip 100c is a 3 strip pack as shown in FIG. 4 that provides 3 healthy snacks loaded with all the daily requirements for vitamins and minerals. These Kids Strips will be taken as a morning snack 10c in between breakfast and lunch and 2 bars 20c, 30c spaced out in between lunch and dinner. The ease and portability allow for the parents to not have to think about or wonder what to give their kids for snacks; you would simply throw this strip into the child's lunch bag or backpack and send them off. Below is a table T-3 that depicts the calorie range of an embodiment of the Kids strip.

TABLE T-3

| Kids Strip | Low Calories | High Calories |
|---|---|---|
| KS | 350 | 600 |

### IV. Athletic Strip

Lean muscle weight gain for athletes is confusing for most because the choices on the market are wide and varied. Most athletes are looking for simple easy to use solutions. The choices today are singular choices of individual meals or supplementation. The athlete is then left to their own dismiss as to how much and how often to take these supplements.

The athletic strip 100d of the present invention eliminates the thinking involved with lean weight gain for athletes is depicted in FIG. 5. The athletic pack pre-determines the caloric intake and number of times to take the individual packet which adds 1,000 calories of high protein-low carb nutrition for lean muscle gain to ones total caloric intake for the day. The athletic strip is a 3 food bar strip that is to be eaten in between mealtimes throughout the day. The first bar 10d is eaten in between breakfast and lunch, the 2^{nd} bar 20d is eaten 2 hours after lunch, the 3^{rd} bar 30d is eaten 2 hours after that and then dinner is eaten after 2 hours after the last bar. Below is Table T-4 that depicts the calorie range for an embodiment of the Athletic strip.

TABLE T-4

| Athletic Strip | Low Calorie | High Calorie |
|---|---|---|
| AS1 | 750 | 1,500 |

### V. Food/Drug Delivery System Strip

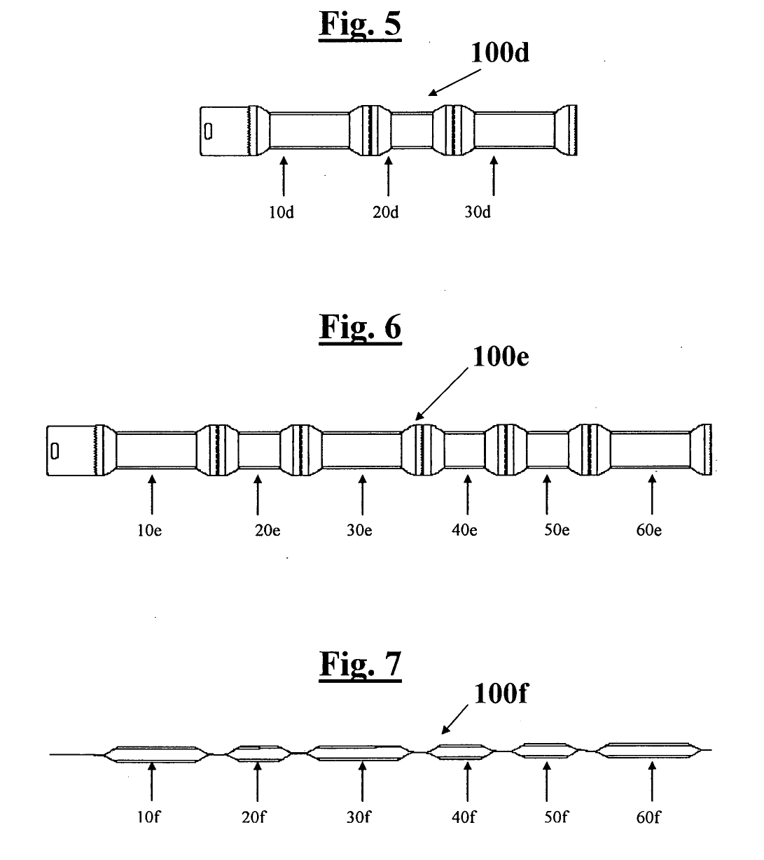

The food/drug delivery system strip 100e as shown in FIG. 6, has six bars and possesses all the attributes of the weight loss strip but also combines a combination of a targeted diet and drug therapy for specific aliments or diseases that require a specific type of diet and drugs in tandem to reduce or cure the aliment or disease. For example a person with high cholesterol requires both a drug to reduce ones cholesterol and also a specific diet low in bad cholesterol and high in good cholesterol. The combination of the drug mixed in with the food is also beneficial because it is released 6 times throughout the day in smaller doses via bars 10e, 20e, 30e, 40e, 50e, 60e that make it easier on the body to absorb and synthesize into the blood. In another embodiment, the strip 100e may be for a person with high blood pressure. This person would require a low sodium diet, along with ones high blood pressure medicine mixed in. In an embodiment, a drug delivery strip 100e may require a prescription from a physician as it includes drugs. Other embodiments of the drug delivery strip 100e may include only drugs that are over the counter and do not need prescriptions. Further embodiments may allow a physician to prescribe whether the drugs are to provided solely in the first, second, third, fourth, fifth or sixth bar. In alternate embodiments a pair of bars may have the drugs. Below is Table T-5 that depicts a calorie range for a first and second group of females and males and a third group in an embodiment of the Drug Delivery strip for person's over 300 pounds.

TABLE T-5

| Food/Drug | | |
|---|---|---|
| Strip | Low Calorie | High Calorie |
| FDF1 | 900 | 1,500 |
| FDF2 | 1,300 | 1,900 |
| FDM1 | 1,450 | 2,050 |
| FDM2 | 1,925 | 2,525 |
| FDT3 | 2,300 | 2,900 |

### VI. Silver Strip

The Silver Strip 100f as depicted in FIG. 7 is targeted to the elderly geriatrics generation. These strips having six bars are specifically formulated to address the needs of growing older and the ailments that are associated with it. There are many elderly people that cannot cook for themselves or shop and the convenience of having a predetermined meal plan of consuming the first bar 10f for breakfast, the second bar 20f for a snack and the third bar 30f for a lunch, a fourth bar 40f for a snack, a fifth bar 50f for a snack and a dinner bar 60f will make eating easier and more healthful for the elderly. The convenience, portability and positive health effects of the Silver Strip 100f for this generation will be most helpful. The men's silver strip will have the proper calories per your weight as well as all the vitamins and minerals of the daily allowances. These silver strips will also have targeted men's nutrients, herbs and foods some examples would be Sal palmetto for prostate health, flax seed for bowel regularity and heart health. Potassium for the heart and muscle cramping. Omega 3 oils for good cholesterol and others to promote men's wellness.

The women's silver strip will have the proper calories per your weight as well as all the vitamins and minerals of the daily allowances. These women's silver strips will also have targeted women's nutrients, herbs and foods some examples would be extra iron and calcium for osteoporoses, flax seed for bowel regularity and heart health. Omega 3 oils for good cholesterol and others to promote women's wellness.

Below is Table T-6 that depicts the calorie range for a first and second group of females and males in an embodiment of the silver strip for elderly people.

TABLE T-6

| Silver Strip | Low Calorie | High Calorie |
|---|---|---|
| SSF1 | 900 | 1,500 |
| SSF2 | 1,300 | 1,900 |
| SSM1 | 1,450 | 2,050 |
| SSM2 | 1,925 | 2,525 |

### VII. Weight Gain Strip

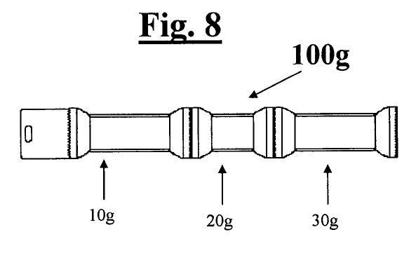

A weight gain strip 100g is shown in FIG. 8 having three bars 10g, 20g, 30g for consumption in between mealtimes in order to provide about 330 calories for each bar in addition to the users intake at breakfast, lunch and dinner.

Below is Table T-7 that depicts a calorie range for an embodiment of a weight gain strip.

TABLE T-7

| Weight Gain | | |
|---|---|---|
| Strip | Low Calorie | High Calorie |
| AS1 | 750 | 1,500 |

### VIII. Weight Loss Strip

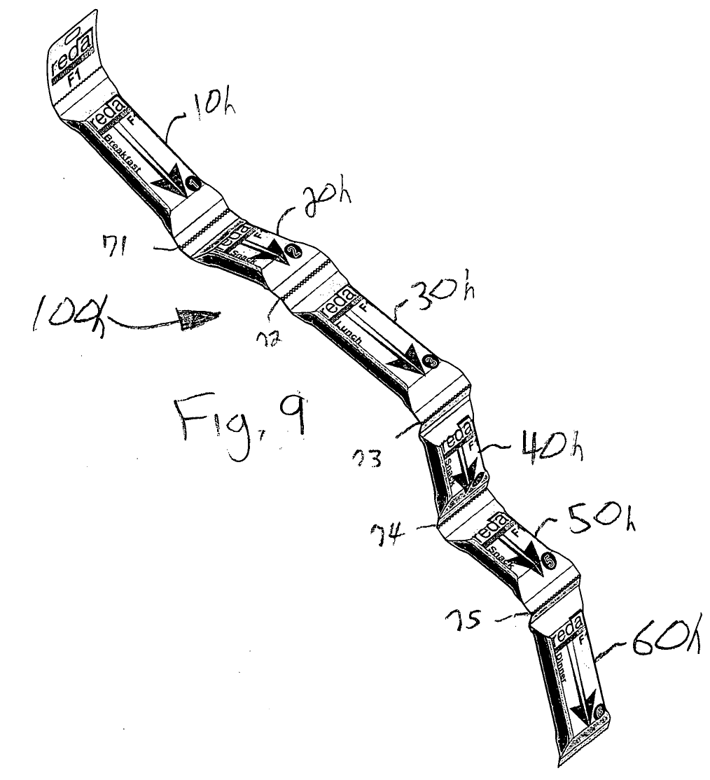

The science behind the weight loss strip 100h as depicted in FIG. 9 is based on how the body reacts to food and calories. In order for your body to optimize its weight loss and fat burning it needs to be activated 6 times a day throughout a 24 hour period. The weight loss strip 100h takes advantage of all these dieting elements and is the easiest diet ever to come along. There are no more excuses for not losing weight. Simplicity is what makes the weight loss strip 100h so useful for the participant. A perforated strip of food bars 100h is provided to be consumed in sequence, 10h, 20h, 30h, 40h, 50h, 60h spaced so many hours apart. You simply start with the number 1 bar and end with the number 6 bar 10 hours later during 24 hour period. Below is Table T-8 that depicts a calorie range for a first and second group of females and males and a third group in an embodiment of the Weight Loss strip 10h for persons over 300 lbs.

TABLE T-8

| | |
|---|---|
| Weight | Calorie Range |

| Loss Strip | Low | High |
|---|---|---|
| WLF1 | 900 | 1,500 |
| WLF2 | 1,300 | 1,900 |
| WLM1 | 1,450 | 2,050 |
| WLM2 | 1,925 | 2,525 |
| WLT3 | 2,300 | 2,900 |

A. Female First (F1) System

In order to develop the present system, the female caloric intake was calculated based on certain weights and ages of females. The Table T-9 below depicts the calculation of such caloric intake to lose 2 pounds per week.

TABLE T-9
FEMALE CALORIC INTAKE

| | | | | |
|---|---|---|---|---|
| 110 | 150 | 175 | 200 | 250 |
| Lbs | Lbs | Lbs | Lbs | Lbs |

20 yr old female

| | | | | | |
|---|---|---|---|---|---|
| Daily caloric intake to | 2123 | 2349 | 2490 | 2631 | 2912 |
| maintain current weight | | | | | |
| Daily caloric intake to | 1123 | 1349 | 1490 | 1631 | 1912 |
| lose 2 lbs per week | | | | | |

Average daily caloric intake to lose 2 lbs per week 1596
30 yr old female

| | | | | | |
|---|---|---|---|---|---|
| Daily caloric intake to | 2050 | 2276 | 2417 | 2557 | 2839 |
| maintain current weight | | | | | |
| Daily caloric intake to | 1050 | 1276 | 1417 | 1557 | 1839 |
| lose 2 lbs per week | | | | | |

Average daily caloric intake to lose 2 lbs per week 1522
40 yr old female

| | | | | | |
|---|---|---|---|---|---|
| Daily caloric intake to | 1977 | 2203 | 2343 | 2484 | 2766 |
| maintain current weight | | | | | |
| Daily caloric intake to | 977 | 1203 | 1343 | 1484 | 1766 |
| lose 2 lbs per week | | | | | |

Average daily caloric intake to lose 2 lbs per week 1449
50 yr old female

| | | | | | |
|---|---|---|---|---|---|
| Daily caloric intake to | 1904 | 2129 | 2270 | 2411 | 2693 |
| maintain current weight | | | | | |
| Daily caloric intake | 904 | 1129 | 1270 | 1411 | 1693 |
| to lose 2 lbs per week | | | | | |

Average daily caloric intake to lose 2 lbs per week 1376

| | | | | | |
|---|---|---|---|---|---|
| | 2050 | 2276 | 2417 | 2557 | 2839 |
| Average 20-50 year old daily | 1014 | 1239 | 1380 | 1521 | 1803 |
| calories to lose 2 lbs per week | | | | | |

Based on the calculations of Table T-9, the present nutrition system was developed for a first female F1 system for females less than 175 pounds and a second female system F2 for females more than 175 pounds. The F1 and F2 systems were chosen to simplify the present nutrition system into solely two categories. However, the present system could also be developed and subdivided into other groups F3, F4, F5 . . . etc.

TABLE T-10

Female System

| | F1 | F2 |
|---|---|---|
| Weight of person | less than | more than |
| | 175 Lbs | 175 Lbs |
| Daily calories to lose | 1,200 | 1,600 |
| 2 lbs per week | | |
| Carbs | 120 g | 160 g |
| Protein | 90 g | 120 g |
| Fat | 40 g | 54 g |

According to the F1 and F2 calculations in Table T-10, the present series of nutrition bars were developed in order to provide a strip of nutrition bars that accomplished the dietary and nutrition goals for F1 as shown in Table T-11 below.

TABLE T-11

| | Break- | Snack | Lunch | Snack | Snack | Dinner |
|---|---|---|---|---|---|---|
| | fast | 2nd | 3rd | 4th | 5th | 6th |
| System-F1 | 1st bar | bar | bar | bar | bar | bar |
| Calories | 263 | 150 | 263 | 150 | 150 | 225 |
| (1,200) | | | | | | |
| Carbs (120 g) | 26 | 15 | 26 | 15 | 15 | 23 |
| Protein (90 g) | 20 | 11 | 20 | 11 | 11 | 17 |
| Fat (40 g) | 9 | 5 | 9 | 5 | 5 | 7 |

An embodiment of the F1 system is shown in FIG. 9 that depicts the first bar 10h labeled No. 1 of a sequentially numbered 6-bar system. The packaged bars have a perforation 71, 72, 73, 74, 75 in between each bar to form a strip of packets. Throughout the day one would peel off each packet in its proper order at the proper pre-determined time to ingest the contents in order to attain the weight loss according to Table T-11. Bar No. 110h has 263 calories, 26 g carbs, 20 g protein and 9 g fat. This is the breakfast bar and it is ingested as the 1^{st} bar in a 6 step process that pre-determines and regulates the number of calories per bar and intervals at which time to eat these bars throughout the day. The reason for this combination is to provide approx: 22% of the total caloric and daily nutritional value of this 6-bar system. It is expected that this combination of components in this first breakfast bar will act to awaken the metabolism from a dormant stage. The flavors and composition of these bars will vary from day to day. The first bar 10h may also have various vitamins, minerals and nutrients in order to provide a pre-determined caloric intake at a pre-determined time to deliver these nutrients as the first installment of a 6-bar system that will culminate into ones total caloric intake at the end of the day.

The F1 system as shown in FIG. 1 depicts the second bar 20h labeled No. 2 of a sequentially numbered 6-bar system. In between bar no 2 20h and bar no 3 30h is where the packaging is perforated 72 to hold the strip together until one would tear the perforation to remove bar No 2. Bar No. 2 is ingested Approx: 2 hours after bar No 1. Bar No 2 is a mid morning snack bar and has 150 calories, 15 g carbs, 11 g protein and 5 g fat. The reason for this combination is to provide Approx: 12.5% of the total caloric and daily nutritional value of this 6-bar system. It is expected that this combination of components in the second bar will act to provide a low calorie snack that will keep the metabolism going in between breakfast and lunch of this 6-bar system. As depicted in FIG. 9, bar no. 2 is smaller in size than bars 1 and 3, as it is a snack and contains less calories etc. The flavors of these bars may vary from day to day. The second bar 20h may also have vitamins, minerals, nutrients and other components in order to provide a pre-determined caloric intake at a pre-determined time to deliver these nutrients as the second installment of the 6-bar system that will culminate into ones total caloric intake at the end of the day.

The F1 system as shown in FIG. 9 depicts the third bar 30h labeled No. 3 of a sequentially numbered 6-bar system. In between bar number 3 and bar number 4 is where the packaging is perforated 73 to hold the strip together until one would tear the perforation to remove bar No 3. Bar No 3 is the lunch bar and is ingested Approx: 2 hours after bar No 2. Bar No 3 has 263 calories, 26 g carbs, 20 g protein and 9 g fat. The reason for this combination is to provide Approx: 22% of the total caloric and daily nutritional value of this 6-bar system. It is expected that this combination of components in the third bar 30h will be to provide a lunch and work to keep the metabolism going at mid day in this 6-bar system. The flavors of this lunch bar 30h may vary from day to day depending on the type of weight loss strip 100h chosen. The third bar 30h may also have minerals, nutrients, vitamins and other components in order to provide a pre-determined caloric intake at a pre-determined time to deliver these nutrients as the third installment 30h of the 6-bar system that will culminate into ones total caloric intake at the end of the day.

The F1 system as shown in FIG. 9 depicts the fourth bar 40h labeled No. 4 of a sequentially numbered 6-bar system. In between bar number 4 and bar number 5 is where the packaging is perforated 74 to hold the strip together until one would tear the perforation to remove bar No 4. Bar No 4 is an early afternoon snack bar and is ingested Approx: 2 hours after bar No 3. Bar No 4 has 150 calories, 15 g carbs, 11 g protein and 5 g fat. The reason for this combination is to provide Approx: 12.5% of the total caloric and daily nutritional value of this 6-bar system. It is expected that this combination of components in the 4^{th} bar will act to provide a early afternoon low calorie snack that will keep the metabolism going in between the lunch bar and late afternoon bar of this 6-bar system. As shown in FIG. 9, the size of the snack bar 40h is smaller than the mealtime bars 10h, 30h and 60h. The flavors of these snack bars may vary from day to day. The 4^{th} bar may also have vitamins, minerals, nutrients and other components in order to provide a pre-determined caloric intake at a pre-determined time to deliver these nutrients as the 4^{th} installment 40h of the 6-bar system that will culminate into ones total caloric intake at the end of the day.

The F1 system as shown in FIG. 9 depicts the fifth bar 50h labeled No. 5 of a sequentially numbered 6-bar system. In between bar number 5 and bar number 6 is where the packaging is perforated 75 to hold the strip together until one would tear the perforation to remove bar No 5. Bar No 5 is a late afternoon snack bar and is ingested Approx: 2 hours after bar No 4. Bar No 5 has 150 calories, 15 g carbs, 11 g protein and 5 g fat. The reason for this combination is to provide Approx: 12.5% of the total caloric and daily nutritional value of this 6-bar system. It is expected that this combination of components in the 5^{th} bar will act to provide a early afternoon low calorie snack that will keep the metabolism going in between the lunch bar and late afternoon bar of this 6-bar system. As shown in FIG. 9, the fifth bar is smaller in size than the mealtime bars 10h, 30h, 60h. The flavors of these snack bars may vary from day to day. The 5^{th} bar may also have vitamins, minerals, nutrients and other components in order to provide a pre-determined caloric intake at a pre-determined time to deliver these nutrients as the 5^{th} installment of the 6-bar system that will culminate into ones total caloric intake at the end of the day.

The F1 system as shown in FIG. 9 depicts the sixth bar 60h labeled No. 6 of a sequentially numbered 6-bar system. Bar number 6 is ingested Approx: 2 hours after bar No 5. Bar No 6 has 225 calories, 23 g carbs, 17 g protein and 7 g fat. This is the dinner bar 60h and the reason for this combination is to provide Approx: 18.5% of the total caloric and daily nutritional value of this 6-bar system. It is expected that this combination of components in this last dinner bar will continue the metabolism hours into the night of this 6-bar system. The flavors of this dinner bar may vary from day to day. The 6^{th} bar may also have vitamins, minerals, nutrients and other components in order to provide a pre-determined caloric intake at a pre-determined time to deliver these nutrients as the 6^{th} installment of the 6-bar system that will culminate into ones total caloric intake at the end of the day.

B. Female Second (F2) System

According to the F1 and F2 calculations in Table T-10, the present series of nutrition bars were developed in order to provide a strip of nutrition bars that accomplished the dietary and nutrition goals for F2 as shown in Table T-12 below.

TABLE T-12

| | Break- | Snack | Lunch | Snack | Snack | Dinner |
|---|---|---|---|---|---|---|
| | fast | 2nd | 3rd | 4th | 5th | 6th |
| System-F2 | 1st bar | bar | bar | bar | bar | bar |
| Calories | 350 | 200 | 350 | 200 | 200 | 300 |
| (1,600) | | | | | | |
| Carbs (160 g) | 35 | 20 | 35 | 20 | 20 | 30 |
| Protein (120 g) | 26 | 15 | 26 | 15 | 15 | 23 |
| Fat (54 g) | 12 | 7 | 12 | 7 | 7 | 10 |

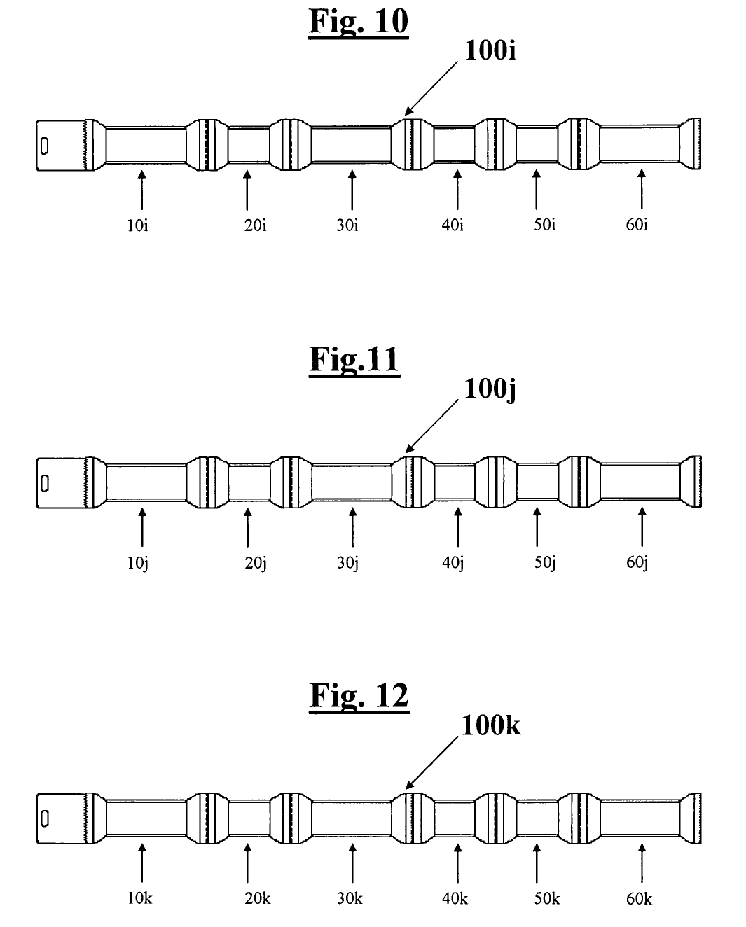

An embodiment of the F2 system is shown in FIG. 10 and depicts a nutrition strip 100i having the first bar labeled No. 1 of a sequentially numbered 6-bar system. The packaged bars have a perforation in between each bar to form a strip of packets. Throughout the day one would peel off each packet in its proper order at the proper pre-determined time to ingest in order to attain the dietary results of Table T-12. Bar No. 1 10i has 350 calories, 35 g carbs, 26 g protein and 12 g fat. This is the breakfast bar 10i and it is ingested as the 1^{st} bar in a 6 step process that pre-determines and regulates the number of calories per bar and intervals at which time to eat these bars throughout the day. The reason for this combination is to provide Approx: 22% of the total caloric and daily nutritional value of this 6-bar system. It is expected that this combination of components in this first breakfast bar will act to awaken the metabolism from a dormant stage. The flavors of this bars will vary from day to day. The first bar may also have vitamins, minerals, nutrients and other components in order to provide a pre-determined caloric intake at a pre-determined time to deliver these nutrients as the first installment of a 6-bar system that will culminate into ones total caloric intake at the end of the day.

The F2 system as shown in FIG. 10 depicts the second bar 20i labeled No. 2 of a sequentially numbered 6-bar system. In between bar no 2 and bar no 3 is where the packaging is perforated to hold the strip together until one would tear the perforation to remove bar No 2. Bar No. 2 is ingested Approx: 2 hours after bar No 1. Bar No 2 is a mid morning snack bar and has 200 calories, 20 g carbs, 15 g protein and 7 g fat. The reason for this combination is to provide Approx: 12.5% of the total caloric and daily nutritional value of this 6-bar system. It is expected that this combination of components in the second bar will act to provide a low calorie snack that will keep the metabolism going in between breakfast and lunch of this 6-bar system. The flavors of these bars may vary from day to day. The second bar may also have vitamins, minerals, nutrients and other components in order to provide a pre-determined caloric intake at a pre-determined time to deliver these nutrients as the second installment of the 6-bar system that will culminate into ones total caloric intake at the end of the day.

The F2 system as shown in FIG. 10 depicts the third bar 30i labeled No. 3 of a sequentially numbered 6-bar system. In between bar number 3 and bar number 4 is where the packaging is perforated to hold the strip together until one would tear the perforation to remove bar No 3. Bar No 3 is the lunch bar and is ingested Approx: 2 hours after bar No 2. Bar No 3 has 350 calories, 35 g carbs, 26 g protein and 12 g fat. The reason for this combination is to provide Approx: 22% of the total caloric and daily nutritional value of this 6-bar system. It is expected that this combination of components in the third bar will be to provide a lunch and work to keep the metabolism going at mid day until the early afternoon snack of this 6-bar system. The flavors of this lunch bar may vary from day to day. The third bar 30i may also have vitamins, minerals, nutrients and other components in order to provide a pre-determined caloric intake at a pre-determined time to deliver these nutrients as the third installment of the 6-bar system that will culminate into ones total caloric intake at the end of the day.

The F2 system as shown in FIG. 10 depicts the fourth bar 40i labeled No. 4 of a sequentially numbered 6-bar system. In between bar number 4 and bar number 5 is where the packaging is perforated to hold the strip together until one would tear the perforation to remove bar No 4. Bar No 4 is an early afternoon snack bar and is ingested Approx: 2 hours after bar No 3. Bar No 4 has 200 calories, 20 g carbs, 15 g protein and 7 g fat. The reason for this combination is to provide Approx: 12.5% of the total caloric and daily nutritional value of this 6-bar system. It is expected that this combination of components in the 4^{th} bar will act to provide a early afternoon low calorie snack that will keep the metabolism going in between lunch and the late afternoon snack of this 6-bar system. The flavors of this bar may vary from day to day. The 4^{th} bar may also have vitamins, minerals, nutrients and other components in order to provide a pre-determined caloric intake at a pre-determined time to deliver these nutrients as the 4^{th} installment of the 6-bar system that will culminate into ones total caloric intake at the end of the day.

The F2 system as shown in FIG. 10 depicts the fifth bar 50i labeled No. 5 of a sequentially numbered 6-bar system. In between bar number 5 and bar number 6 is where the packaging is perforated to hold the strip together until one would tear the perforation to remove bar No 5. Bar No 5 is ingested Approx: 2 hours after bar No 4. Bar No 5 has 200 calories, 20 g carbs, 15 g protein and 7 g fat. The reason for this combination is to provide Approx: 12.5% of the total caloric and daily nutritional value of this 6-bar system. It is expected that this combination of components in the 5^{th} bar will act to provide a low calorie snack that will keep the metabolism going in between the early afternoon snack and dinner of this 6-bar system. The flavors of this bar may vary from day to day. The 5^{th} bar may also have vitamins, minerals, nutrients and other components in order to provide a pre-determined caloric intake at a pre-determined time to deliver these nutrients as the 5^{th} installment of the 6-bar system that will culminate into ones total caloric intake at the end of the day.

The F2 system as shown in FIG. 10 depicts the sixth bar 60i labeled No. 6 of a sequentially numbered 6-bar system. Bar No 6 is ingested Approx: 2 hours after bar No 5. Bar No 6 has 300 calories, 30 g carbs, 23 g protein and 10 g fat. The reason for this combination is to provide Approx: 18.5% of the total caloric and daily nutritional value of this 6-bar system. It is expected that this combination of components in the 6^{th} and final bar will keep the metabolism going hours into the night of this 6-bar system. The flavors of this bar may vary from day to day. The 6^{th} bar may also have vitamins, minerals, nutrients and other components in order to provide a pre-determined caloric intake at a pre-determined time to deliver these nutrients as the 6^{th} installment of the 6-bar system that will culminate into ones total caloric intake at the end of the day.

C. Male First (M1) System

In order to develop the present system, the male caloric intake was calculated based on certain weights and ages of males. The Table T-13 below depicts the calculation of such caloric intake to lose 2 pounds per week.

TABLE T-13
MALE CALORIC INTAKE

| | | | | |
|---|---|---|---|---|
| 150 Lbs | 200 Lbs | 225 Lbs | 250 Lbs | 300 Lbs |

20 yr old male

| | | | | | |
|---|---|---|---|---|---|
| Daily caloric intake to | 2753 | 3114 | 3294 | 3474 | 3835 |
| maintain current weight | | | | | |
| Daily caloric intake to | 1753 | 2114 | 2294 | 2474 | 2835 |
| lose 2 lbs per week | | | | | |

Average daily caloric intake to lose 2 lbs per week 2294
30 yr old male

| | | | | | |
|---|---|---|---|---|---|
| Daily caloric intake to | 2656 | 3017 | 3197 | 3377 | 3738 |
| maintain current weight | | | | | |
| Daily caloric intake | 1656 | 2017 | 2197 | 2377 | 2738 |
| to lose 2 lbs per week | | | | | |

Average daily caloric intake to lose 2 lbs per week 2197
40 yr old male

| | | | | | |
|---|---|---|---|---|---|
| Daily caloric intake to | 2559 | 2919 | 3100 | 3280 | 3641 |
| maintain current weight | | | | | |
| Daily caloric intake to | 1559 | 1919 | 2100 | 2280 | 2641 |
| lose 2 lbs per week | | | | | |

Average daily caloric intake to lose 2 lbs per week 2100
50 yr old male

| | | | | | |
|---|---|---|---|---|---|
| Daily caloric intake to | 2462 | 2822 | 3003 | 3183 | 3543 |
| maintain current weight | | | | | |
| Daily caloric intake to | 1462 | 1822 | 2003 | 2183 | 2543 |
| lose 2 lbs per week | | | | | |

Average daily caloric intake to lose 2 lbs per week 2003

| | | | | | |
|---|---|---|---|---|---|
| | 2608 | 2968 | 3149 | 3329 | 3689 |
| Average 20-50 year old | 1608 | 1968 | 2149 | 2329 | 2689 |
| daily calories to lose | | | | | |
| 2 lbs per week | | | | | |

Based on the calculations of Table T-13, the present nutrition system was developed for a first male M1 system for males less than 225 pounds and a second male system M2 for males more than 225 pounds. The M1 and M2 systems were chosen to simplify the present nutrition system into solely two categories. However, the present system could also be developed and subdivided into other groups M3, M4, M5 . . . etc.

TABLE T-14

Male System

| | M1 | M2 |
|---|---|---|
| Weight of person | less than | more than |
| | 225 Lbs | 225 Lbs |
| Daily calories to | 1,750 | 2,225 |
| lose 2 lbs per week | | |
| Carbs | 157 g | 223 g |
| Protein | 132 g | 167 g |
| Fat | 59 g | 75 g |

According to the M1 and M2 calculations in Table T-14, the present series of nutrition bars were developed in order to provide a strip of nutrition bars that accomplished the dietary and nutrition goals for M1 as shown in Table T-15 below.

TABLE T-15

| | Break- | Snack | Lunch | Snack | Snack | Dinner |
|---|---|---|---|---|---|---|
| | fast | 2nd | 3rd | 4th | 5th | 6th |
| System-M1 | 1st bar | bar | bar | bar | bar | bar |
| Calories | 403 | 200 | 403 | 200 | 200 | 345 |
| (1,750) | | | | | | |
| Carbs (175 g) | 40 | 20 | 40 | 20 | 20 | 35 |
| Protein (132 g) | 30 | 15 | 30 | 15 | 15 | 26 |
| Fat (59 g) | 13 | 7 | 13 | 7 | 7 | 11 |

An embodiment of the M1 system is shown in FIG. 11 and depicts a nutrition strip 100j having the first bar 10j labeled No. 1 of a sequentially numbered 6-bar system. The packaged bars have a perforation in between each bar to form a strip of packets. Throughout the day one would peel off each packet in its proper order at the proper pre-determined time to ingest in order to attain the dietary goals outlined in Table T-15. Bar No 1 has 403 calories, 40 g carbs, 30 g protein and 13 g fat. This is the breakfast bar and it is ingested as the 1^{st} bar in a 6 step process that predetermines and regulates the number of calories per bar and intervals at which time to eat these bars throughout the day. The reason for this combination is to provide Approx: 22% of the total caloric and daily nutritional value of this 6-bar system. It is expected that this combination of components in this first breakfast bar will act to awaken the metabolism from a dormant stage. The flavors of this bar may vary from day to day. The first bar may also have vitamins, minerals, nutrients and other components in order to provide a pre-determined caloric intake at a pre-determined time to deliver these nutrients as the first installment of a 6-bar system that will culminate into ones total caloric intake at the end of the day.

The M1 system as shown in FIG. 11 depicts the second bar 20j labeled No. 2 of a sequentially numbered 6-bar system. In between bar no 2 and bar no 3 is where the packaging is perforated to hold the strip together until one would tear the perforation to remove bar No 2. Bar No 2 is ingested Approx: 2 hours after bar No 1. Bar No 2 is a low calorie mid morning snack bar and has 200 calories, 20 g carbs, 15 g protein and 7 g fat. The reason for this combination is to provide Approx: 12.5% of the total caloric and daily nutritional value of this 6-bar system. It is expected that this combination of components in the second bar will act to provide a low calorie snack that will keep the metabolism going in between breakfast and lunch of this 6-bar system. The flavors of this bar may vary from day to day. The second bar may also have vitamins, minerals, nutrients and other components in order to provide a pre-determined caloric intake at a pre-determined time to deliver these nutrients as the second installment of the 6-bar system that will culminate into ones total caloric intake at the end of the day.

The M1 system as shown in FIG. 11 depicts the third bar 30j labeled No. 3 of a sequentially numbered 6-bar system. In between bar number 3 and bar number 4 is where the packaging is perforated to hold the strip together until one would tear the perforation to remove bar No 3. Bar No 3 is the lunch bar and is ingested Approx: 2 hours after bar. No 2. Bar No 3 has 403 calories, 40 g carbs, 30 g protein and 13 g fat. The reason for this combination is to provide Approx: 22% of the total caloric and daily nutritional value of this 6-bar system. It is expected that this combination of components in the lunch bar will be to provide lunch and work to keep the metabolism going at mid day until the early afternoon snack of this 6-bar system. The flavors of this bar may vary from day to day. The third bar may also have vitamins, minerals, nutrients and other components in order to provide a pre-determined caloric intake at a pre-determined time to deliver these nutrients as the third installment of the 6-bar system that will culminate into ones total caloric intake at the end of the day.

The M1 system as shown in FIG. 11 depicts the fourth bar 40j labeled No. 4 of a sequentially numbered 6-bar system. In between bar number 4 and bar number 5 is where the packaging is perforated to hold the strip together until one would tear the perforation to remove bar No 4. Bar No 4 is an early afternoon low calorie snack and is ingested Approx: 2 hours after bar No 3. Bar No 4 has 200 calories, 20 g carbs, 15 g protein and 7 g fat. The reason for this combination is to provide Approx: 12.5% of the total caloric and daily nutritional value of this 6-bar system. It is expected that this combination of components in the 4th bar will act to provide a early afternoon low calorie snack that will keep the metabolism going in between lunch and late afternoon snack of this 6-bar system. The flavors of this bar may vary from day to day. The 4^{th} bar may also have vitamins, minerals, nutrients and other components in order to provide a pre-determined caloric intake at a pre-determined time to deliver these nutrients as the 4^{th} installment of the 6-bar system that will culminate into ones total caloric intake at the end of the day.

The M1 system as shown in FIG. 11 depicts the fifth bar 50j labeled No. 5 of a sequentially numbered 6-bar system. In between bar number 5 and bar number 6 is where the packaging is perforated to hold the strip together until one would tear the perforation to remove bar No 5. Bar No 5 is a late afternoon low calorie snack bar and is ingested Approx: 2 hours after bar No 4. Bar No 5 has 200 calories, 20 g carbs, 15 g protein and 7 g fat. This is the late afternoon snack and the reason for this combination is to provide Approx: 12.5% of the total caloric and daily nutritional value of this 6-bar system. It is expected that this combination of components in the 5^{th} bar will act to provide a low calorie snack that will keep the metabolism going in between the early afternoon bar and dinner of this 6-bar system. The flavors in this bar may vary from day to day. The 5^{th} bar may also have vitamins, minerals, nutrients and other components in order to provide a pre-determined caloric intake at a pre-determined time to deliver these nutrients as the 5^{th} installment of the 6-bar system that will culminate into ones total caloric intake at the end of the day.

The M1 system as shown in FIG. 11 depicts the sixth bar 60j labeled No. 6 of a sequentially numbered 6-bar system. Bar No 6 is the dinner bar and is ingested Approx: 2 hours after bar No 5. Bar No 6 has 398 calories, 40 g carbs, 30 g protein and 13 g fat. The reason for this combination is to provide Approx: 18.5% of the total caloric and daily nutritional value of this 6-bar system. It is expected that this combination of components in this 6^{th} and final dinner bar will keep the metabolism going hours into the night of this 6-bar system. The flavors of this bar may vary from day to day. The 6^{th} bar may also have vitamins, minerals, nutrients and other components in order to provide a pre-determined caloric intake at a pre-determined time to deliver these nutrients as the 6^{th} installment of the 6-bar system that will culminate into ones total caloric intake at the end of the day.

D. Male Second (M2) System

According to the M1 and M2 calculations in Table T-14, the present series of nutrition bars were developed in order to provide a strip of nutrition bars that accomplished the dietary and nutrition goals for M2 as shown in Table T-16 below.

TABLE T-16

| | Break- | Snack | Lunch | Snack | Snack | Dinner |
|---|---|---|---|---|---|---|
| | fast | 2nd | 3rd | 4th | 5th | 6th |
| System-M2 | 1st bar | bar | bar | bar | bar | bar |
| Calories | 464 | 300 | 464 | 300 | 300 | 398 |
| (2,225) | | | | | | |
| Carbs (223 g) | 46 | 30 | 46 | 30 | 30 | 40 |
| Protein (167 g) | 35 | 23 | 35 | 23 | 23 | 30 |
| Fat (75 g) | 15 | 10 | 15 | 10 | 10 | 13 |

An embodiment of the M2 system is shown in FIG. 12 and depicts a nutrition strip 100k having the first bar 10k labeled No. 1 of a sequentially numbered 6-bar system. The packaged bars have a perforation in between each bar to form a strip of packets. Throughout the day one would peel off each packet in its proper order at the proper pre-determined time to ingest in order to attain the dietary goals outlined in Table T-16. Bar. No 1 has 463 calories, 46 g carbs, 35 g protein and 15 g fat. This is the breakfast bar and it is ingested as the 1^{st} bar in a 6 step process that pre-determines and regulates the number of calories per bar and intervals at which time to eat these bars throughout the day. The reason for this combination is to provide Approx: 22% of the total caloric and daily nutritional value of this 6-bar system. It is expected that this combination of components in this first bar will act to awaken the metabolism from a dormant stage. The flavors in this bar may vary from day to day. The first bar may also have vitamins, minerals, nutrients and other components in order to provide a pre-determined caloric intake at a pre-determined time to deliver these nutrients as the first installment of a 6-bar system that will culminate into ones total caloric intake at the end of the day.

The M2 system as shown in FIG. 12 depicts the second bar 20k labeled No. 2 of a sequentially numbered 6-bar system. In between bar no 2 and bar no 3 is where the packaging is perforated to hold the strip together until one would tear the perforation to remove bar No 2. Bar No 2 is ingested Approx: 2 hours after bar No 1. Bar No 2 is a low calorie mid morning snack bar and has 300 calories, 30 g carbs, 23 g protein and 10 g fat. The reason for this combination is to provide Approx: 12.5% of the total caloric and daily nutritional value of this 6-bar system. It is expected that this combination of components in the second bar will act to provide a low calorie snack that will keep the metabolism going in between breakfast and lunch of this 6-bar system. The flavors of this bar may vary from day to day. The second bar may also have vitamins, minerals, nutrients and other components in order to provide a pre-determined caloric intake at a pre-determined time to deliver these nutrients as the second installment of the 6-bar system that will culminate into ones total caloric intake at the end of the day.

The M2 system as shown in FIG. 12 depicts the third bar 30k labeled No. 3 of a sequentially numbered 6-bar system. In between bar number 3 and bar number 4 is where the packaging is perforated to hold the strip together until one would tear the perforation to remove bar No 3. Bar No 3 is the lunch bar and is ingested Approx: 2 hours after bar No 2. Bar No 3 has 464 calories, 46 g carbs, 35 g protein and 9 g fat. The reason for this combination is to provide Approx: 22% of the total caloric and daily nutritional value of this 6-bar system. It is expected that this combination of components in this lunch bar will be to provide lunch and work to keep the metabolism going at mid day until the early afternoon snack of this 6-bar system. The third bar may also have vitamins, minerals, nutrients and other components in order to provide a pre-determined caloric intake at a pre-determined time to deliver these nutrients as the third installment of the 6-bar system that will culminate into ones total caloric intake at the end of the day.

The M2 system as shown in FIG. 12 depicts the fourth bar 40k labeled No. 4 of a sequentially numbered 6-bar system. In between bar number 4 and bar number 5 is where the packaging is perforated to hold the strip together until one would tear the perforation to remove bar No 4. Bar No 4 is an early afternoon low calorie snack and is ingested Approx: 2 hours after bar No 3. Bar No 4 has 200 calories, 20 g carbs, 15 g protein and 7 g fat. The reason for this combination is to provide Approx: 12.5% of the total caloric and daily nutritional value of this 6-bar system. It is expected that this combination of components in the 4th bar will act to provide a low calorie snack that will keep the metabolism going in between lunch and the late afternoon snack of this 6-bar system. The flavors of this bar may vary from day to day. The 4^{th} bar may also have vitamins, minerals, nutrients and other components in order to provide a pre-determined caloric intake at a pre-determined time to deliver these nutrients as the 4^{th} installment of the 6-bar system that will culminate into ones total caloric intake at the end of the day.

The M2 system as shown in FIG. 12 depicts the fifth bar 50k labeled No. 5 of a sequentially numbered 6-bar system. In between bar number 5 and bar number 6 is where the packaging is perforated to hold the strip together until one would tear the perforation to remove bar No 5. Bar No 5 is a late afternoon low calorie snack bar and is ingested Approx: 2 hours after bar No 4. Bar No 5 has 300 calories, 30 g carbs, 23 g protein and 10 g fat. The reason for this combination is to provide Approx: 12.5% of the total caloric and daily nutritional value of this 6-bar system. It is expected that this combination of components in the 5^{th} bar will act to provide a low calorie snack that will keep the metabolism going in between early afternoon snack and dinner of this 6-bar system. The flavors of this bar may vary from day to day. The 5^{th} bar may also have vitamins, minerals, nutrients and other components in order to provide a pre-determined caloric intake at a pre-determined time to deliver these nutrients as the 5^{th} installment of the 6-bar system that will culminate into ones total caloric intake at the end of the day.

The M2 system as shown in FIG. 12 depicts the sixth bar 60k labeled No. 6 of a sequentially numbered 6-bar system. Bar No 6 is ingested Approx: 2 hours after bar No 5. Bar No 6 has 150 calories, 15 g carbs, 11 g protein and 5 g fat. The reason for this combination is to provide Approx: 18.5% of the total caloric and daily nutritional value of this 6-bar system. It is expected that this combination of components in this 6^{th} and final dinner bar will keep the metabolism going hours into the night of this 6-bar system. The flavors of this bar may vary from day to day. The 6^{th} bar may also have vitamins, minerals, nutrients and other components in order to provide a pre-determined caloric intake at a pre-determined time to deliver these nutrients as the 6^{th} installment of the 6-bar system that will culminate into ones total caloric intake at the end of the day.

The food delivery system of the present invention is an improvement over other diet systems in that this food delivery systems doesn't require the participant to think about counting calories, points, fat, preparing food, cooking, or any of the pitfalls of the current diets. The delivery system pre-determines and regulates for the participant the number of calories per serving and intervals of time at which to eat these serving. The delivery system requires no cooking or preparing of food. The food delivery system requires no refrigeration. The food delivery system is contained in sealed wrappers and is portable enough to be carried in a purse or brief case.

The nutritional strip is a diet program that eliminates all the pit falls of the current and typical diets to both lose weight. The current diets on the market require a lot of time and energy on the part of the participant trying to lose weight. You may need to count calories, count points, count fat, count carbohydrates, cook special food day in and day out, plan meals far in advance, call a service for your food, consider your work conditions or environment for cooking or processing the food and transporting the food for your daily consumption. These conditions are very time consuming and causes great stress on the participants of these diets. These diets have short-term results because of this.

The nutritional strip has considered these conditions and has solved them in a very creative and healthy way. The nutritional strip has also considered the physical aspect of dieting and how the body's metabolism and biorhythms work. The nutritional strip has eliminated the work and thinking of dieting, there are no decisions to be made, no calories to count, no points to count, no cooking and no unproven chemical laced pills to take when you are on the nutritional strip. The nutritional strip has pre-made all these decisions for you to get you to your ideal weight.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. For example, covering components, other than a heat sink and cages other than transceiver receptacles may be shielded by the gasket of the present invention. The actual scope of the protection sought is intended to be defined in the following claims when viewed in their proper perspective based on the prior art.

What is claimed is:

1. A series of nutrition bars having a composition comprising:
a first nutrition bar having a first amount of calories, carbohydrates, protein and fats;
a second nutrition bar having a second amount of calories, carbohydrates, protein and fats;
a third nutrition bar having a third amount of calories, carbohydrates, protein and fats; and
the first, second and third nutrition bars combined in series so that the first, second and third amounts of calories, carbohydrates, protein and fats providing a total daily intake of calories, carbohydrates, protein and fats that attain a predetermined daily dietary plan for an individual.

2. The composition of claim 1 wherein the first, second and third nutrition bars provide a total of between about 900 to 2,900 calories daily, 60 to 223 grams of carbohydrates daily, 50 to 167 grams of protein daily and 0 to 75 grams of fat daily.

3. A system for controlling caloric intake comprising:
a series of at least three food bars packaged together in a strip;
each food bar is separated from the next and may be removed from the strip without disrupting the adjacent food bar; and
each food bar is labeled in order to identify a sequence by which the food bars are to be consumed so that upon ingestion of each of the food bars a total daily caloric intake will be achieved and the total caloric intake consistent with a predetermined diet plan.

4. The system of claim 3 wherein the specified diet plan is for weight reduction, gain or maintenance.

5. The system of claim 3 wherein the specified diet plan is for women.

6. The system of claim 3 wherein the specified diet plan is for men.

7. The system of claim 3 wherein the specified diet plan is for elderly dietary needs.

8. The system of claim 3 wherein the specified diet plan is for sports training.

9. The system of claim 3 wherein the specified diet plan is for treatment of diabetes, high blood pressure, high cholesterol or high sodium.

10. The system of claim 3 wherein the specified diet plan is for optimal drug delivery combined with a specific nutritional composition.

11. The system of claim 10 wherein the nutritional composition is predetermined and coordinated with the specified drug being delivered by each bar of the strip.

12. The system of claim 3 wherein the specified diet plan is for a children's diet.

13. The system of claim 3 wherein at least one food bar is a snack bar and at least one food bar is a mealtime bar and each food bar labeled so that the snack bar is directed to be consumed about two hours after the mealtime bar in order to stimulate the user's metabolism.

14. A system for controlling caloric intake comprising a strip that contains six food bars and at least two of the food bars are designated as snack bars and at least two of the food bars are designated as mealtime bars and each food bar is labeled so that the snack bars are directed to be consumed about two hours after the mealtime bar in order to stimulate the user's metabolism.

15. A method of controlling caloric intake and stimulating a users metabolism over a daily duration comprising the steps of:
providing a series of at least three food bars packaged together in a strip;
removing a first food bar labeled with the numeral “1” from the strip and consuming the food bar as first meal;
removing a second food bar labeled with the numeral “2” from the strip and consuming the food bar as a second meal about two hours after the first meal;
removing a third food bar labeled with the numeral “3” from the strip and consuming the food bar as a third meal about two hours after the second meal; and
consuming a total predetermined caloric intake in order to provide prescribed diet plan.

16. The method of claim 15 wherein the method of removal comprises the step of tearing along perforation between each bar.

17. The method of claim 15 further comprising the steps of removing a fourth food bar labeled with the numeral “4” from the strip and consuming the food bar as a fourth meal about two hours after the third meal.

18. The method of claim 17 further comprising the steps of removing a fifth food bar labeled with the numeral “5” from the strip and consuming the food bar as a fifth meal about two hours after the fourth meal.

19. The method of claim 18 further comprising the steps of removing a sixth food bar labeled with the numeral “6” from the strip and consuming the food bar as a sixth meal about two hours after the fifth meal.

20. The method of claim 19 wherein the first bar contains between about 213 to 464 calories, the second bar contains between about 100 to 300 calories, the third bar contains between about 213 to 464 calories, the fourth bar contains between about 100 to 300 calories, the fifth bar contains between about 100 to 300 calories and the sixth bar contains between about 175 to 398 calories.

21. The method of claim 19 wherein the first bar contains between about 9 to 42 grams of protein, the second bar contains between about 5 to 23 grams of protein, the third bar contains between about 9 to 42 grams of protein, the fourth bar contains between about 5 to 23 grams of protein, the fifth bar contains between about 5 to 23 grams of protein and the sixth bar contains between about 7 to 37 grams of protein.

22. The method of claim 19 wherein the first bar contains between about 1 to 20 grams of fats, the second bar contains between about 1 to 8 grams of fat, the third bar contains between about 1 to 20 grams of fat, the fourth bar contains between about 1 to 8 grams of fat, the fifth bar contains between about 1 to 8 grams of fat and the sixth bar contains between about 1 to 20 grams of fat.

23. The method of claim 19 wherein the first bar contains between about 10 to 75 carbs, the second bar contains between about 7 to 33 carbs, the third bar contains between about 10 to 75 carbs, the fourth bar contains between about 7 to 33 carbs, the fifth bar contains between about 7 to 33 carbs and the sixth bar contains between about 10 to 75 carbs.

24. The method of claim 19 wherein the first, third and sixth food bars contain a higher amount of calories than the second, fourth and fifth food bars so that consumption of the series of second, fourth and fifth food bars causes the users metabolism to be stimulated.

25. The method of claim 19 wherein the first food bar contains a higher amount of calories than the second food bar and the third food bar contains a higher amount of calories than the second food bar so that consumption of the series of three food bars causes the users metabolism to be stimulated.
